(19) United States
(12) Patent Application Publication
(10) Pub. No.: US 2015/0093728 A1
(43) Pub. Date: Apr. 2, 2015

(54) Learning Estimation Method and Computer System thereof

(71) Applicant: Wistron Corporation, New Taipei City (TW)

(72) Inventors: Yueh-Hsien Lin, New Taipei City (TW); Yu-Ling Chan, New Taipei City (TW); Chih-Kai Huang, New Taipei City (TW); Chih-Kang Chen, New Taipei City (TW)

(73) Assignee: Wistron Corporation, New Taipei City (TW)

(21) Appl. No.: 14/248,328

(22) Filed: Apr. 8, 2014

(30) Foreign Application Priority Data
Oct. 2, 2013 (TW) 102135726

(51) Int. Cl. G09B 5/00

(52) U.S. Cl. CPC G09B 5/00
USPC 434/236; 434/322

(57) ABSTRACT

A learning estimation method comprises tagging an identification tag on a learning object, recording a learning result corresponding to the learning object when a learner utilizes the learning object to process a learning operation, and obtaining an analytical result for the learner according to the learning result and a learning principle, wherein the identification tag is utilized to recognize characteristics of the learning object.

### BACKGROUND OF THE INVENTION

1. Field of the Invention

The present invention relates to a learning estimation method and a computer system thereof, and more particularly, to a learning estimation method and a computer system thereof which correspondingly obtains an analytical result of one learner via a plurality of learning objects tagged with a plurality of identification tags.

2. Description of the Prior Art

Generally, it is important to provide proper education for different people with different educational background. According to different learning patterns associated with a learner during his/her learning process, it is also important to discover/realize a specific learning characteristic of the learner, so as to provide suitable learning processes or contents for the learner. The specific learning characteristic of the learner may be understood as a learning capability/comprehension, a thinking process and a recognition characteristic while the learner deals with different problems. However, most non-digital learning products/systems only provide a one-way teaching solution, and common digital learning products/systems merely provide the learner an interactive way and record a learning result of the learner at the end of the learning process, but lacks fully recording the corresponding learning patterns of the learner during the learning process.

Thus, it is important to provide another learning estimation method and computer system thereof to obtain the mentioned specific learning characteristic of the learner, so as to be adaptively utilized for following analysis and determination.

### SUMMARY OF THE INVENTION

It is therefore an objective of the invention to provide a learning estimation method and a computer system thereof, so as to correspondingly obtain an analytical result of one learner via a plurality of learning objects tagged with a plurality of identification tags.

An embodiment of the invention discloses a learning estimation method. The learning estimation method comprises tagging a plurality of identification tags on a plurality of learning objects; recording a learning result corresponding to the plurality of learning objects when a learner utilizes the plurality of learning objects to process a learning operation; and obtaining an analytical result of the learner according to the learning result and a learning principle; wherein the plurality of identification tags are utilized to recognize characteristics of the plurality of learning objects.

An embodiment of the invention discloses a computer system. The computer system comprises a central processing unit; and a storage device, coupled to the central processing unit and storing a programming code, the programming code is utilized to process a learning estimation method. The learning estimation method comprises tagging a plurality of identification tags on a plurality of learning objects; recording a learning result corresponding to the plurality of learning objects when a learner utilizes the plurality of learning objects to process a learning operation; and obtaining an analytical result of the learner according to the learning result and a learning principle; wherein the plurality of identification tags are utilized to recognize characteristics of the plurality of learning objects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a computer system according to an embodiment of the invention.

FIG. 2 illustrates a flow chart of a learning estimation process according to an embodiment of the invention.

FIG. 3 illustrates a schematic diagram of a learning operation as the Tangram game according to an embodiment of the invention.

FIG. 4 illustrates a schematic diagram of operations of different learners operating the Tangram game according to an embodiment of the invention.

FIG. 5 illustrates a schematic diagram of a consequence of different learners operating the Tangram game according to an embodiment of the invention.

FIG. 6 illustrates a schematic diagram of a learning operation as the board game according to an embodiment of the invention.

FIG. 7 illustrates an initial situation of the board game according to an embodiment of the invention.

FIG. 8 to FIG. 10 illustrate schematic diagrams of consequences of different learners operating the board game according to an embodiment of the invention.

FIG. 11 illustrates a schematic diagram of a learning operation as the board game according to an embodiment of the invention.

FIG. 12 illustrates a schematic diagram of operations of different learners operating the block game according to an embodiment of the invention.

FIG. 13 illustrates a schematic diagram of a consequence of different learners operating the block game according to an embodiment of the invention.

### DETAILED DESCRIPTION

The specification and the claims of the present invention may use a particular word to indicate an element, which may have diversified names named by distinct manufacturers. The present invention distinguishes the element depending on its function rather than its name. The phrase “comprising” used in the specification and the claim is to mean “is inclusive or open-ended but not exclude additional, un-recited elements or method steps.” In addition, the phrase “electrically connected to” or “coupled” is to mean any electrical connection in a direct manner or an indirect manner. Therefore, the description of “a first device electrically connected or coupled to a second device” is to mean that the first device is connected to the second device directly or by means of connecting through other devices or methods in an indirect manner.

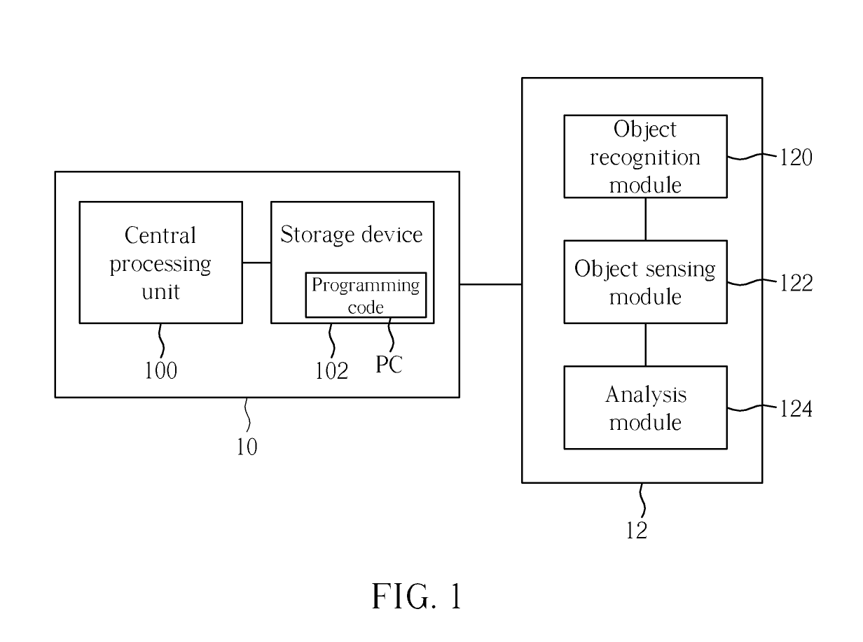

Please refer to FIG. 1, which illustrates a schematic diagram of a computer system 10 according to an embodiment of the invention. The computer system 10 has a basic structure comprising a main board, a processing unit, a memory, a hard disk, a south-bridge module, a north-bridge module, and etc, and should be well known to those skilled in the art. For the brevity, FIG. 1 of the invention only illustrates a central processing unit 100 and a storage device 102 of the computer system 10, and the computer system 10 is also coupled to an estimation system 12. The estimation system 12 of the invention comprises an object recognition module 120, an object sensing module 122 and an analysis module 124. The storage device 102 can be, but not limited to, read-only memory (ROM), random-access memory (RAM), flash, floppy disk, hardware disk, compact disc, USB flash drive, tape, database accessed via the Internet, or other types of storage medium known to those skilled in the art, to store a programming code PC, such that the central processing unit 100 can be utilized to process the programming code PC to operate a learning estimation method for the computer system 10.

In simple, the learning estimation method of the invention instructs the computer system 10 and the estimation system 12 to cooperate with different learning operations, and the learning operations can be utilized to determine a personal capability/comprehension, a thinking process and a recognition characteristic corresponding to a game played/processed by the learner. In the embodiment, the game can be a Tangram game, a board game or a block game, which is not limiting the scope of the invention. According to different learning operations (i.e. different games), the embodiment of the invention can provide different learning objects. Also, the storage device 102 stores a learning principle corresponding to the different learning operations. During processing the learning operation, the computer system 10 and the estimation system 12 can be adaptively cooperated together to control the object recognition module 120 and the object sensing module 122 for recording a learning result of the learner, so as to control the analysis module 124 to analyze/compare differences between the learning principle and the learning result for correspondingly obtaining an analytical result of the learner. The learning principle can correspond to at least one of the learning operations, and the game designer can compile the learning principle to be another programming code and stored in the storage device 102 and/or the analysis module 124.

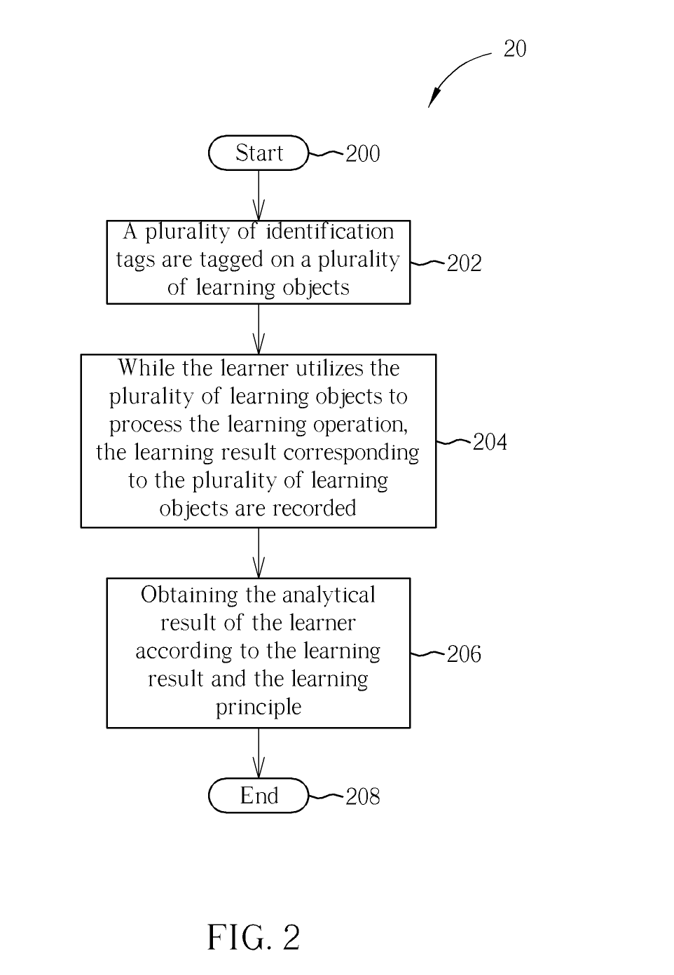

Further, the learning estimation method for the computer system 10 of the invention can be summarized as a learning estimation process 20 to be compiled as the programming code stored in the storage device 102, as shown in FIG. 2. The learning estimation process 20 includes the following steps.

Step 200: Start.

Step 202: A plurality of identification tags are tagged on a plurality of learning objects.

Step 204: While the learner utilizes the plurality of learning objects to process the learning operation, the learning result corresponding to the plurality of learning objects are recorded.

Step 206: Obtaining the analytical result of the learner according to the learning result and the learning principle.

Step 208: End.

In the embodiment, the learner can pre-select one learning operation, i.e. the learner may select one of the different games to process the learning operation, and the learning principle corresponding to the learning operation can be adaptively stored in the storage device 102 as well. During the learning operation, one user can adaptively adjust/modify the learning principle to dynamically estimate the learning result of the learner, which is not limiting the scope of the invention. In step 202, once the learner chooses the learning operation, the plurality of learning objects corresponding to the learning operation can be decided, accordingly, and the plurality of identification tags can also be adaptively tagged onto the plurality of learning objects. The plurality of learning objects comprises a plurality of characteristics, such that the plurality of identification tags can be utilized to identify the different characteristics of the plurality of learning objects. For example, the plurality of characteristics comprise external differences as titles (names), types, shapes, sizes, colors to be recognized, and the learning objects tagged the plurality of identification tags can be recognized by the object recognition module 120.

In step 204, when the learner utilizes the plurality of learning objects to process the learning operation, the computer system 10 or the estimation system 12 can record the learning result corresponding to the plurality of learning objects. The learning operation can comprise different learning instructions to guide/instruct the learner for operating the plurality of learning objects, so as to properly process the learning operation. Besides, the learner may comprehend the learning instructions on his/her own way, as mentioned in step 204, such that the learner can process the learning operation while the learner is instructed by the learning principle. The object sensing module 122 can be utilized to detect how the learner operates the plurality of learning objects, so as to correspondingly generate/obtain the learning result of the learner.

Noticeably, for convenient descriptions, the embodiment of the invention utilizes the object recognition module 120 to recognize the plurality of identification tags of the plurality of learning objects, and utilizes the object sensing module 122 to record the operational way of the plurality of learning objects performed by the learner. Certainly, those skilled in the art can adaptively integrate the functions of the object recognition module 120 as well as the object sensing module 122 to have the object sensing module 122 equipped with the function of the object recognition module 120, such that only the object sensing module 122 can be utilized to recognize the plurality of identification tags for sensing related operations of the plurality of learning objects during the learning operation, which is also in the scope of the invention.

Additionally, while the learner operates the plurality of learning objects, the object sensing module 122 obtains the different learning results, and accordingly, the computer system 10 or the estimation system 12 can store the learning result of the learner. Noticeably, since different learning principles have been stored in the computer system 10 or the estimation system 12, the object sensing module 122 can obtain the learning result of the learner according to the operational way of the plurality of learning objects processed by the learner. Referring to the different learning principles, the learning result can comprise a similarity parameter, a transformation parameter, a period parameter or an object configuration parameter corresponding to the plurality of identification tags of the plurality of learning objects processed by the leaner.

For example, the learning instruction is utilized to instruct the learner for arranging a plurality of Tangram boards and obtaining a target pattern, such as a square. After the learner finishes the arrangement of the plurality of Tangram boards, the learning result correspondingly appears to be a triangle. Under such circumstances, the similarity parameter is utilized to tell differences between the square and the triangle, such as a shape difference or a length-to-width ratio difference. The transformation parameter is utilized to tell how the learner constitutes/figures out the target pattern. For example, the learner initially obtains a plurality of small squares, and then combines the plurality of small squares to obtain the target pattern as a big square. The period parameter is utilized to tell a total period for the learner finishing the target pattern. The object configuration parameter is utilized to tell a sequence for arranging the plurality of Tangram boards. For example, after reading the learning instruction, the learner initially arranges the plurality of Tangram boards from a top-right portion of the target pattern. Certainly, according to different learning instructions, those skilled in the art can adaptively add/modify/delete the mentioned parameters and corresponding realizations, so as to obtain the suitable learning result of the learner for analyzing the personal pattern of the learner, which is also in the scope of the invention.

In step 206, the analysis module 124 can obtain the analytical result of the learner according to the learning result and the learning principle. Preferably, according to the learning result, the analysis module 124 can obtain a learner input result corresponding to operations performed by the learner for the plurality of learning objects, and then, a cooperation of the analysis module 124 and the computer system 10 generates the analytical result for the learner after comparing the differences between the learner input result and the learning principle.

In the embodiment, the analytical result comprises determining a learning goal achievement percentage, a responsive rate, a thinking process or a cognitive psychology of the learner. In other words, different learners can understand/comprehend the learning operation on their own ways, such that the object recognition module 120 and the object sensing module 122 can be utilized to record differences of the plurality of identification tags during the learning operation, so as to obtain the learning result. The analysis module 124 can correspondingly obtain an effective result for the learner operating different learning operations in view of the learning result (i.e. the learner input result) and the learning principle. In comparison with the conventional digital/non-digital learning products/systems, the embodiment of the invention can entirely obtain/record all possible personal patterns while the learner processes the learning operation, such that different analytical results can be adaptively generated according to different operational ways performed by the learner, to completely retrieve/gather the at least three personal patterns as the personal capability/comprehension, the thinking process and the recognition characteristic of the learner, so as to fully understand/analyze the learning characteristic of the learner via the different learning operations.

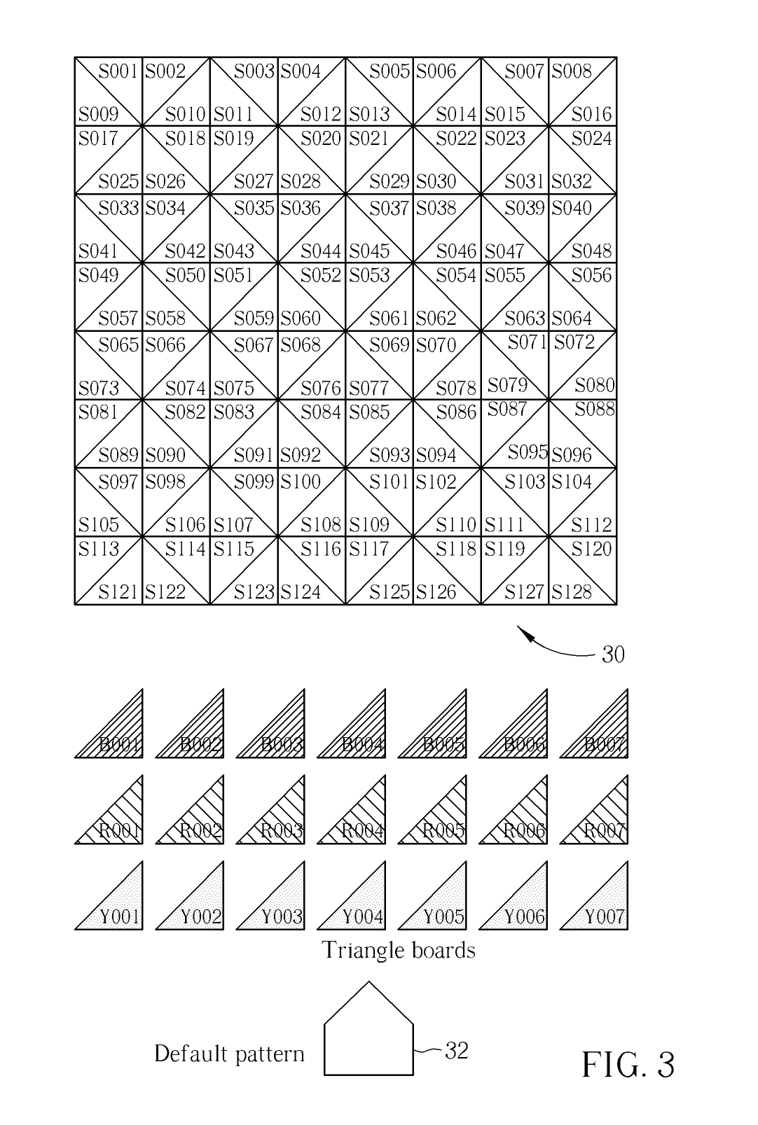

Please refer to FIG. 3, which illustrates a schematic diagram of a learning operation as the Tangram game according to an embodiment of the invention. As shown in FIG. 3, the Tangram game comprises a base board 30 and a plurality of triangle boards. The base board 30 integrates functions of the object recognition module 120 and the object sensing module 122, and can be adaptively divided into a plurality of sensing zones having equal size. The plurality of sensing zones are realized as triangle zones to be numbered as S001-S128. The plurality of triangle boards have three colors as red, yellow and blue, and are sequentially numbered as R001-R007, Y001-Y007 and B001-B007. Besides, the Tangram game can predetermine a default pattern 32 (i.e. the learning principle) to be a housing pattern, and the learning instructions can be realized as wording/picture descriptions to inform the learner of how to arrange the plurality triangle boards forming another pattern complying with the default pattern on the base board 30.

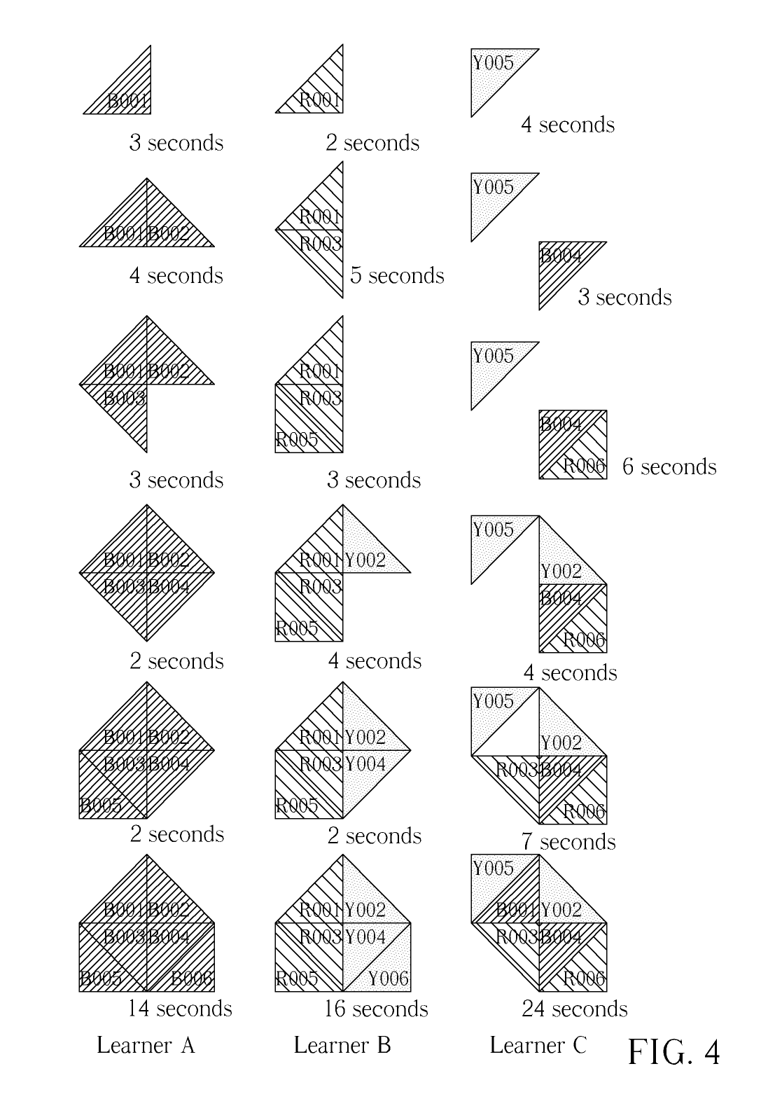

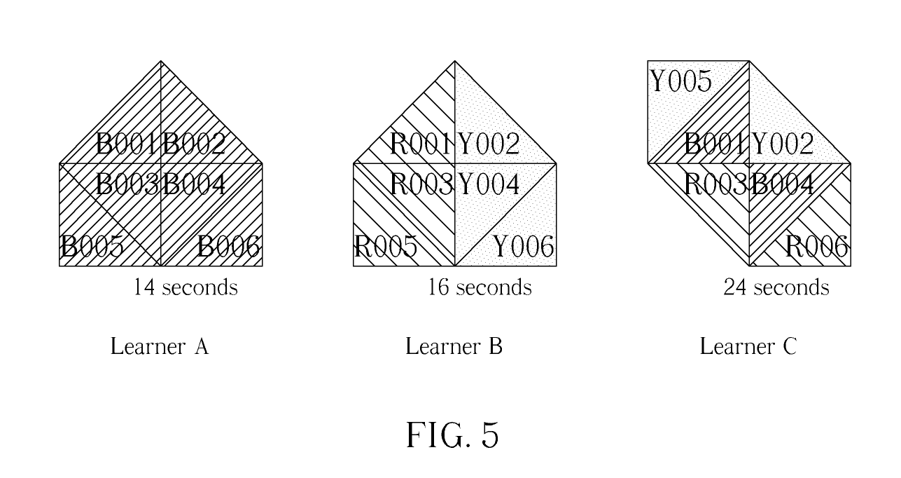

Please refer to FIG. 4 and FIG. 5, wherein FIG. 4 illustrates a schematic diagram of operations of different learners A-C operating the Tangram game according to an embodiment of the invention, and FIG. 5 illustrates a schematic diagram of a consequence of different learners A-C operating the Tangram game according to an embodiment of the invention. As shown in FIG. 4 and FIG. 5, after the learners A-C read the learning instructions and the default pattern 32, they can sequentially select different triangle boards with different colors to be disposed on the base board 30 during arrangement operations of the learners A-C. Under such circumstances, the object recognition module 120 and the object sensing module 122 can be utilized to record/observe how the learners A-C sequentially dispose the triangle boards with different colors at different periods/positions, so as to obtain the learning results of the leaners A-C. When the learners A-C finish the arrangement operations, the embodiment of the invention not only records the arrangement operations of the learners A-C, such as the final patterns and the colors as well as numbers of the utilized triangle boards, but also records the thinking process and corresponding solutions of the leaners A-C about how to finish the default pattern 32 at different periods/positions. Next, the analysis module 124 determines the learning characteristics of the leaners A-C according to the differences of the learning result (i.e. the learner input result) and the learning principle. For example, in the embodiment, the leaner A has a correct pattern/profile comprehension with the least considering periods; the learner B has the correct pattern/profile comprehension as well as the best color/three-dimension comprehension; the learner C has an incorrect pattern/profile comprehension but has the best color/three-dimension comprehension and a sense of symmetry, which only shows demonstrations for understanding without limiting the scope of the invention.

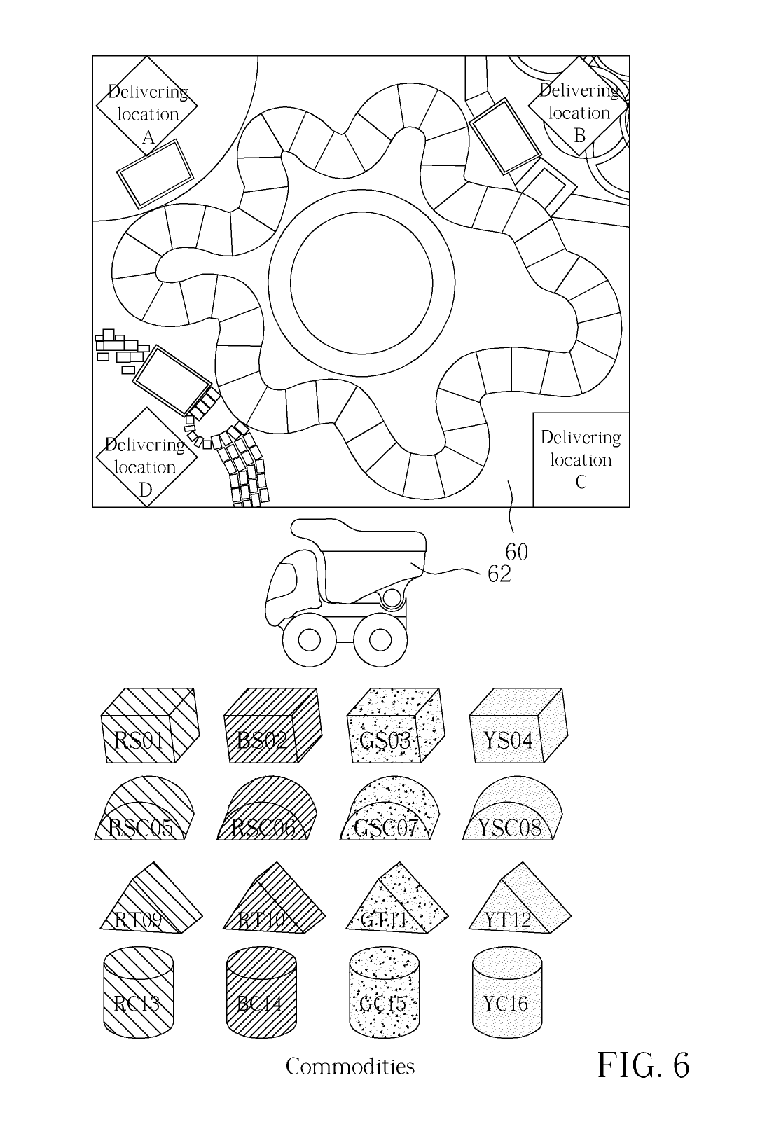

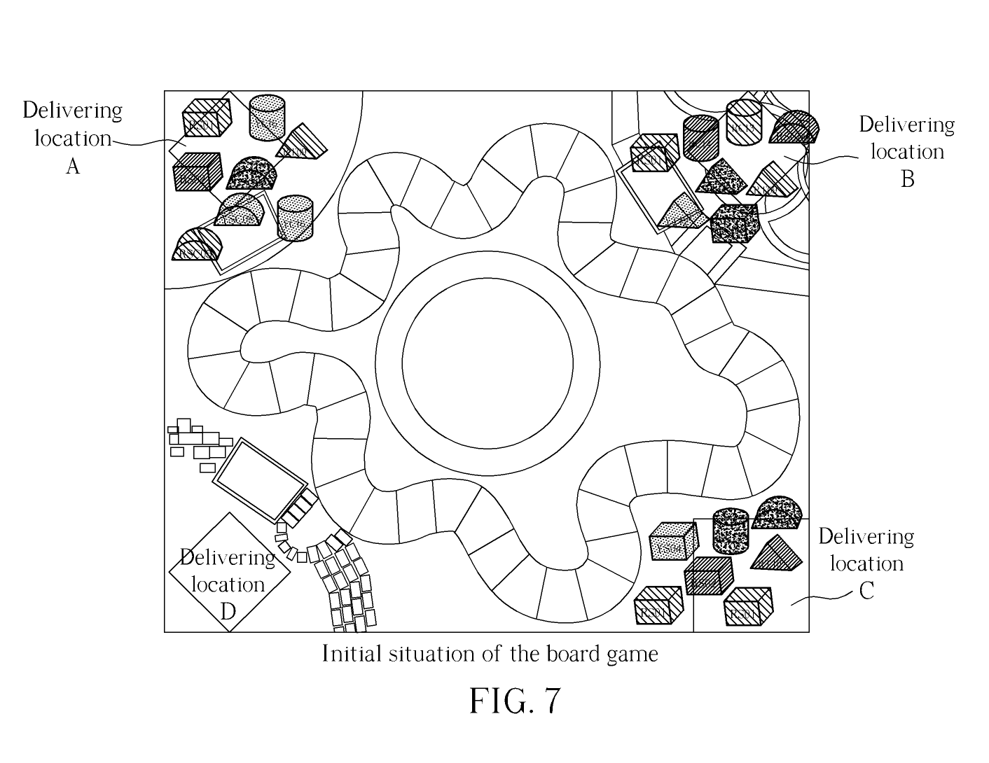

Please refer to FIG. 6 and FIG. 7, wherein FIG. 6 illustrates a schematic diagram of a learning operation as the board game according to an embodiment of the invention, and FIG. 7 illustrates an initial situation of the board game according to an embodiment of the invention. As shown in FIG. 6, the board game comprises a map 60, a delivering truck 62 and a plurality of commodities. The map 60 and the delivering truck 62 integrate the functions of the object recognition module 120 and the object sensing module 122. The map 60 is divided into four delivering locations A-D. The plurality of commodities are initially disposed at different delivering locations A-C and marked with different identifications tags for representing different spatial shapes and colors, such as the identification tag of RS01 representing the commodity being a red square, and the identification tag of BSC06 representing the commodity being a blue semi-cylinder. Besides, the board game predetermines a target delivering location (i.e. the learning principle) to be the delivering locations D, and the learning instructions can be the wording/figure descriptions to instruct the learner how to utilize the delivering truck 62 for gathering and delivering the plurality of commodities to the delivering locations D with four red commodities on the map 60.

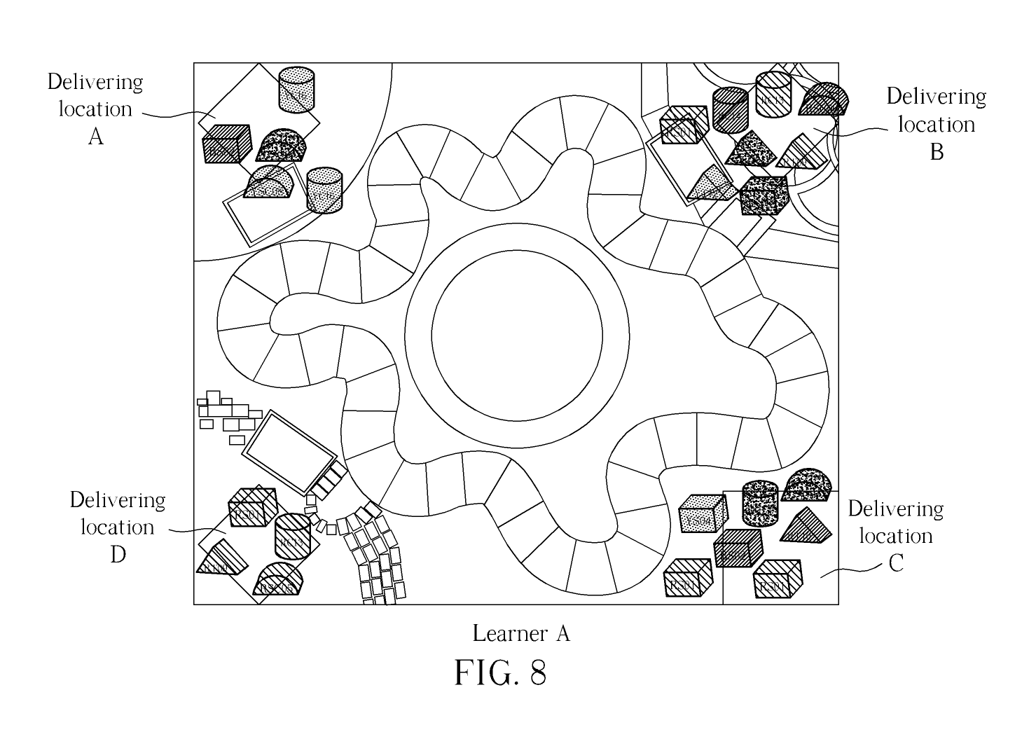

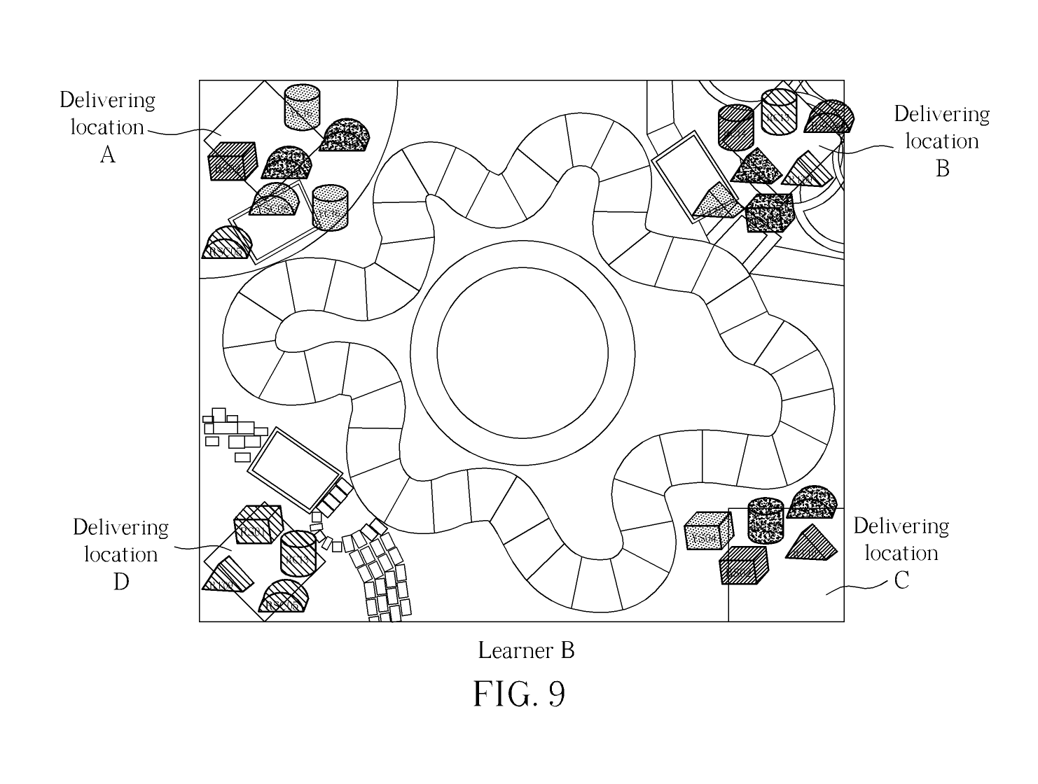

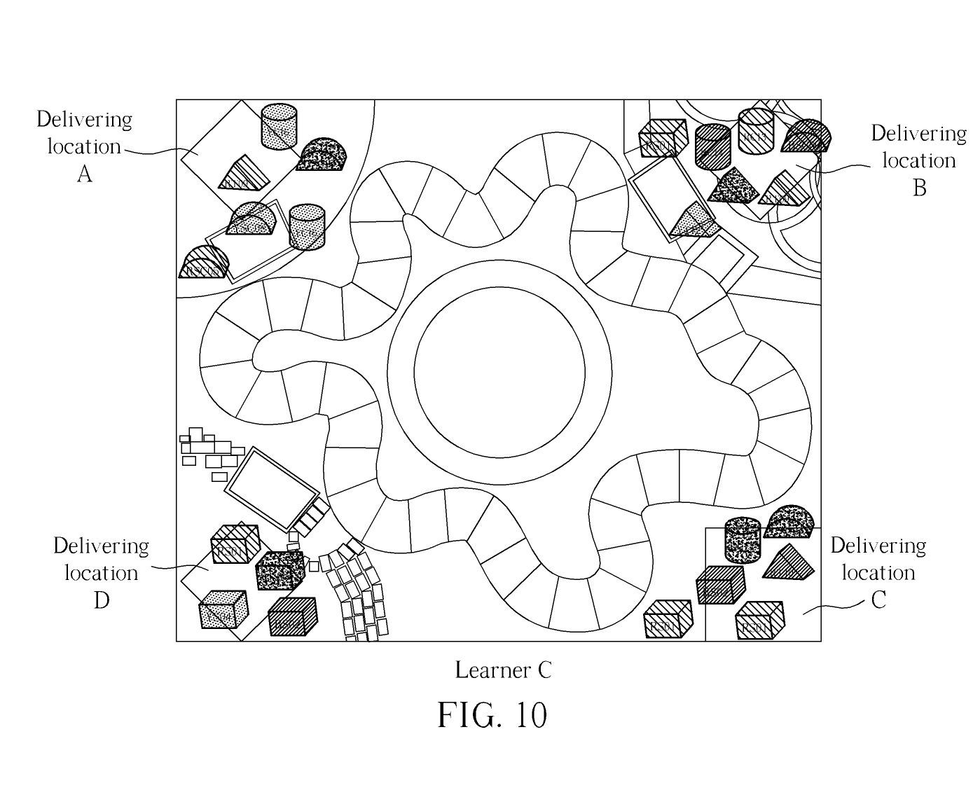

Please refer to FIG. 8 to FIG. 10, which illustrate schematic diagrams of consequences of different learners A-C operating the board game according to an embodiment of the invention. After the learners A-C read the learning instructions, they may sequentially utilize the delivering truck 62 to gather and deliver the plurality of commodities disposed on the delivering locations A-C, so as to deliver different colors/shapes of the plurality of commodities to the delivering location D. In the embodiment, the object recognition module 120 and the object sensing module 122 integrated inside the map 60 and the delivering truck 62 can be utilized to entirely record delivering operations of how the learners A-C gather and deliver the plurality of commodities at different periods, locations and sequences, so as to obtain/generate delivering results of the learners A-C. When the learners A-C finish their delivering operations, the embodiment of the invention not only records the delivering operations of the learners A-C, as shown in FIG. 8 to FIG. 10, but also records the thinking process and corresponding solutions of the leaners A-C about how to achieve/accomplish the learning instructions at different periods/positions/sequences. Next, the analysis module 124 can be utilized to determine the learning characteristics of the leaners A-C according to the learning result (i.e. the learner input result) and the learning principle. For example, the leaner A has a correct pattern/profile comprehension; the learner B has the correct pattern/profile comprehension as well as a better geometry comprehension; the learner C has an incorrect pattern/profile comprehension but has the best geometry comprehension, which shows demonstrations for understanding the embodiment without limiting the scope of the invention.

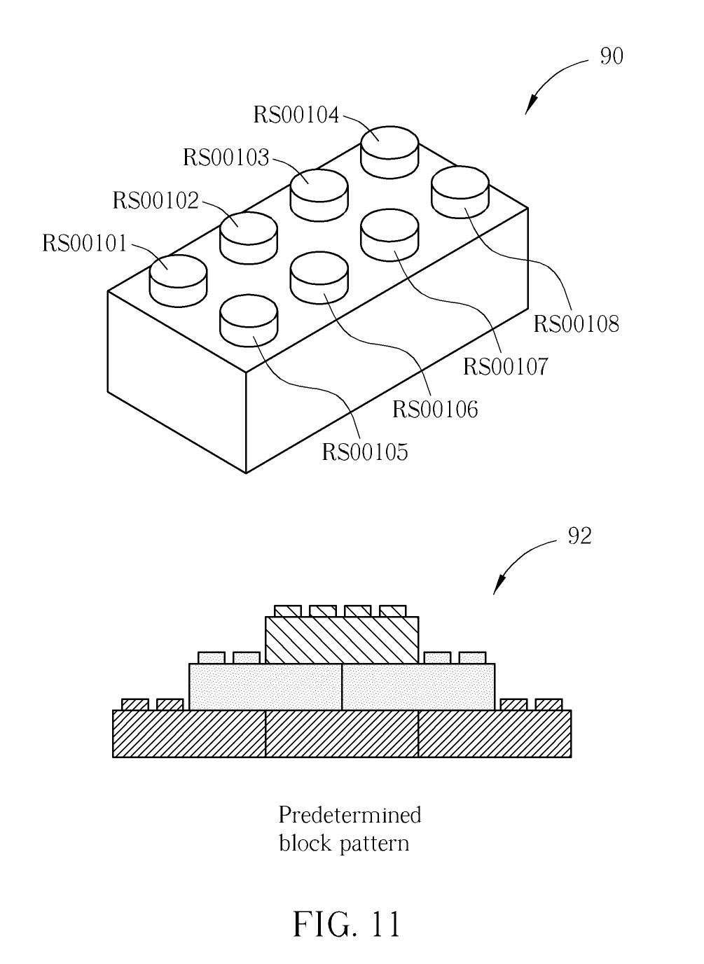

Please refer to FIG. 11, which illustrates a schematic diagram of a learning operation as the board game according to an embodiment of the invention. For clear descriptions, FIG. 11 only depicts one of a plurality of blocks 90 and a predetermined block pattern 92 (i.e. the learning principle) corresponding to the block game. The block game comprises the plurality of blocks being different colors and the same shapes, and each block 90 comprises a plurality of connections to be sequentially marked with identifications as RS00101-RS00108I. In the meanwhile, each block 90 integrates the functions of the object recognition module 120 and the object sensing module 122. Besides, the learning instructions of the block game can be the wording/figure descriptions to instruct the learner how to utilize the plurality of blocks to complete a combination according to the predetermined block pattern 92.

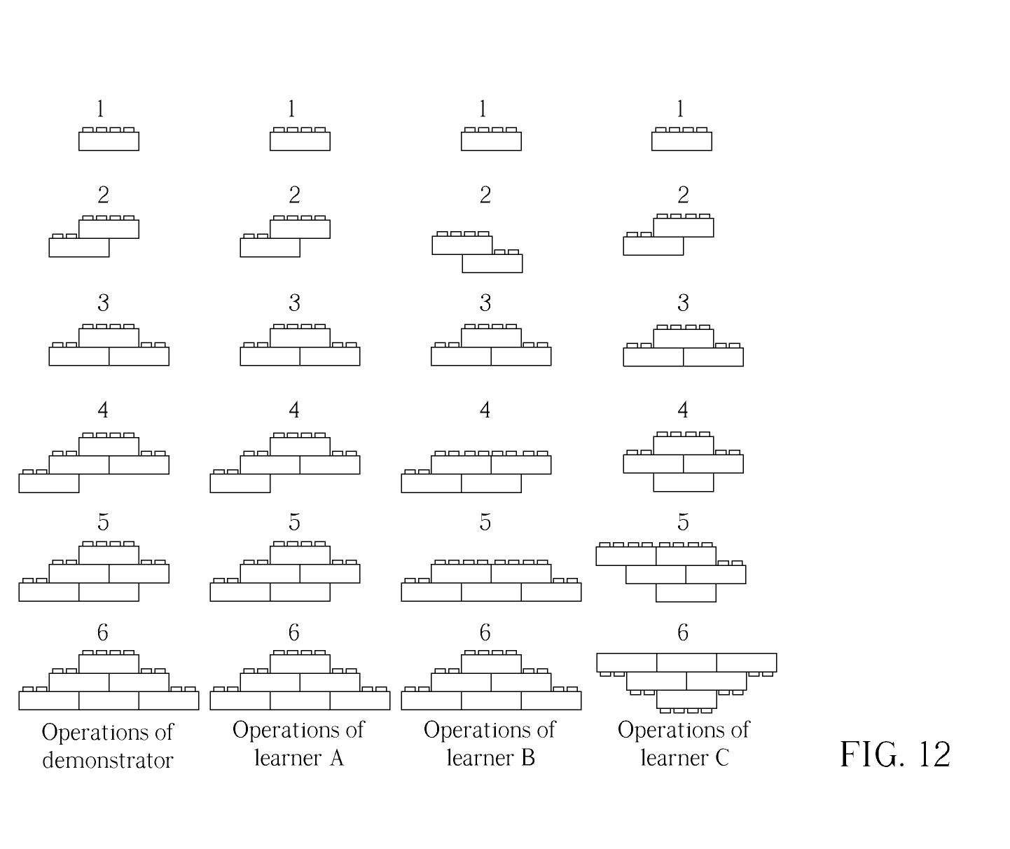

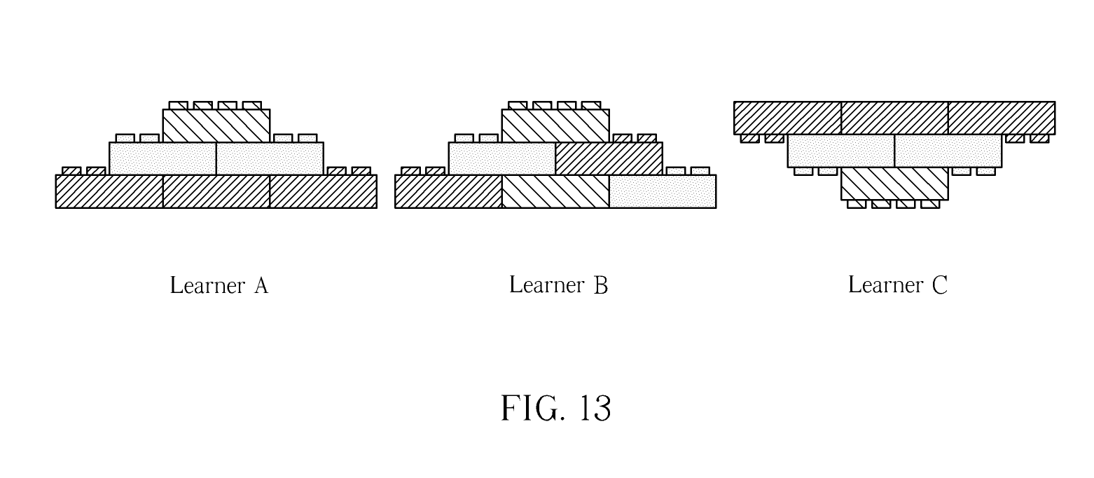

Please refer to FIG. 12 and FIG. 13, wherein FIG. 12 illustrates a schematic diagram of operations of different learners A-C operating the block game according to an embodiment of the invention, and FIG. 13 illustrates a schematic diagram of a consequence of different learners A-C operating the block game according to an embodiment of the invention. As shown in FIG. 12 and FIG. 13, after the learners A-C read the learning instructions and the predetermined block pattern 92 and watch an example about how to combine the plurality of blocks from a demonstrator, they may sequentially utilize the plurality of blocks with different colors to finish their combination operations. Under such circumstances, the object recognition module 120 and the object sensing module 122 integrated with the plurality of blocks can be utilized to entirely record how the learners A-C sequentially combine the plurality of blocks with different colors at different periods, locations and sequences, so as to obtain/generate combination results of the learners A-C. When the learners A-C finish their combination operations, the embodiment of the invention not only records the combination operations of the learners A-C, as shown in FIG. 13, but also records the thinking process and corresponding solutions of the leaners A-C about how to achieve/accomplish the predetermined block pattern 92 at different periods/positions/sequences. Next, the analysis module 124 can be utilized to determine the learning characteristics of the leaners A-C according to the learning result (i.e. the learner input result) and the learning principle. For example, the leaner A has a correct geometry comprehension as well as a correct logic comprehension; the learner B has the correct geometry comprehension as well as a better imitation capability, but has a poor color comprehension; the learner C has an incorrect geometry comprehension but has a best senses of symmetry and creativity, which shows demonstrations for understanding the embodiment without limiting the scope of the invention.

In other words, the embodiment of the invention provides three demonstrations of the learning operation to be applied to different learning objects as well as learning principles, and the object recognition module 120, the object sensing module 122 and the analysis module 124 can be adaptively integrated/disposed in the learning objects or other learning operational elements, which is also in the scope of the invention. Besides, the embodiment of the invention is not limiting a realization/demonstration of how to tag the plurality of identification tags on/in the plurality of learning objects, such that the plurality of identification tags can be adaptively attached/fixed/stuck on or in the plurality of learning objects according different realizations of the plurality of learning objects, which may also provide a convenience of the object recognition module 120 and the object sensing module 122 to easily detect and record the corresponding learning result from the learner.

The embodiment of the invention is utilized to measure/compare/analyze the learning result of the leaner during the learning operation; the learning result (i.e. the learner input result) can be utilized to represent any feasibly/easily observed subject factors, objective factors or variables; and the analytical result is utilized to determine the learning reference factors while the learner utilizes the different learning operations. Thus, those skilled in the art can correspondingly design different learning estimation parameters according to any interested learning operations or learning results, such as the regularity, adaptation or emotional characteristics of the learner, and thus, to combine with the mentioned embodiments for analyzing the geometry comprehension, the color/three-dimension comprehension and the sense of symmetry or creativity, so as to entirely retrieve/obtain the at least three personal patterns as the learning capability/comprehension, the thinking process and the recognition characteristic while the learner deals with different problems. Accordingly, the individual learning characteristics of the different learners can be discovered via different types of learning operations, which is also in the scope of the invention.

Noticeably, the computer system 10 and the estimation system 12 can be utilized to operate the learning estimation process 20, such that after different learners adaptively select the learning operations, they can analyze/discover their own learning characteristics during their learning operations. Certainly, those skilled in the art can adaptively combine other digital/non-digital games/systems with the mentioned embodiments, such that the learner may utilize another input interface or an interactive interface to dynamically process the learning operations. In the meanwhile, the computer system 10 and the estimation system 12, and the learning the estimation system 12 can provide another option to dynamically adjust the learning principle and processes/contents of the learning operations, so as to meet one interested particular learning characteristic of the learner. For example, when the learner is determined/analyzed to have a better profile/figure comprehension, and accordingly, the learning operation as well as the learning principle can be adaptively modified to further discover/determine whether the leaner is equipped/inherited with a better two-dimension profile/figure comprehension or a better three-dimension profile/figure comprehension, which is also in the scope of the invention.

In summary, the embodiment of the invention provides the learning estimation method and the computer system thereof. By utilizing the plurality of identification tags tagging on/in the plurality of learning objects, the learning result corresponding to one learner can be adaptively recorded while the learner processes the learning operation, such that the analytical result corresponding to the learning operation of the learner can be obtained and analyzed. Accordingly, while the learner deals with different problems, the personal patterns of the learner can be quantified to be different learning reference parameters, such as parameters for determining the learning capability/comprehension, the thinking process and the recognition characteristic, to discover the individual learning characteristics of the learner.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A learning estimation method, comprising:
tagging a plurality of identification tags on a plurality of learning objects;
recording a learning result corresponding to the plurality of learning objects when a learner utilizes the plurality of learning objects to process a learning operation; and
obtaining an analytical result of the learner according to the learning result and a learning principle;
wherein the plurality of identification tags are utilized to recognize characteristics of the plurality of learning objects.

2. The learning estimation method of claim 1, wherein the characteristics comprise external differences as titles, types, shapes, sizes, colors to be recognized.

3. The learning estimation method of claim 2, wherein the learning result comprises a similarity parameter, a transformation parameter, a period parameter or an object configuration parameter corresponding to the plurality of identification tags of the plurality of learning objects.

4. The learning estimation method of claim 3, wherein the step of obtaining the analytical result of the learner according to the learning result and the learning principle comprises:
obtaining a learner input result corresponding to the plurality of learning objects operated by the learner according to the leaning result; and
comparing differences between the learner input result and the learning principle, to obtain the analytical result of the learner.

5. The learning estimation method of claim 4, wherein the analytical result comprises determining a learning goal achievement percentage, a responsive rate, a thinking process or a cognitive psychology of the learner.

6. The learning estimation method of claim 5, further comprising utilizing an object recognition module and an object sensing module to record changes of the plurality of identification tags while the learning operation is being processed, so as to obtain the learning result, and utilizing an analysis module predetermining the learning principle to obtain the analytical result of the learner according to the learning result.

7. The learning estimation method of claim 1, wherein the learning result comprises a similarity parameter, a transformation parameter, a period parameter or an object configuration parameter corresponding to the plurality of identification tags of the plurality of learning objects.

8. The learning estimation method of claim 1, wherein the step of obtaining the analytical result of the learner according to the learning result and the learning principle comprises:
obtaining a learner input result corresponding to the plurality of learning objects operated by the learner according to the leaning result; and
comparing differences between the learner input result and the learning principle, to obtain the analytical result of the learner.

9. The learning estimation method of claim 8, wherein the analytical result comprises determining a learning goal achievement percentage, a responsive rate, a thinking process or a cognitive psychology of the learner.

10. The learning estimation method of claim 1, further comprising utilizing an object recognition module and an object sensing module to record changes of the plurality of identification tags while the learning operation is being processed, so as to obtain the learning result, and utilizing an analysis module predetermining the learning principle to obtain the analytical result of the learner according to the learning result.

11. A computer system, comprising:
a central processing unit; and
a storage device, coupled to the central processing unit and storing a programming code, the programming code is utilized to process a learning estimation method, the learning estimation method comprising:
tagging a plurality of identification tags on a plurality of learning objects;
recording a learning result corresponding to the plurality of learning objects when a learner utilizes the plurality of learning objects to process a learning operation; and
obtaining an analytical result of the learner according to the learning result and a learning principle;
wherein the plurality of identification tags are utilized to recognize characteristics of the plurality of learning objects.

12. The computer system of claim 11, wherein the characteristics comprise external differences as titles, types, shapes, sizes, colors to be recognized.

13. The computer system of claim 12, wherein the learning result comprises a similarity parameter, a transformation parameter, a period parameter or an object configuration parameter corresponding to the plurality of identification tags of the plurality of learning objects.

14. The computer system of claim 13, wherein the step of obtaining the analytical result of the learner according to the learning result and the learning principle of the learning estimation method further comprises:
obtaining a learner input result corresponding to the plurality of learning objects operated by the learner according to the leaning result; and
comparing differences between the learner input result and the learning principle, to obtain the analytical result of the learner.

15. The computer system of claim 14, wherein the analytical result comprises determining a learning goal achievement percentage, a responsive rate, a thinking process or a cognitive psychology of the learner.

16. The computer system of claim 15, further being coupled to a estimation system comprising an object recognition module, an object sensing module, and an analysis module, wherein the object recognition module and the object sensing module are utilized to record changes of the plurality of identification tags while the learning operation is being processed, so as to obtain the learning result, and the analysis module predetermining the learning principle is utilized to obtain the analytical result of the learner according to the learning result.

17. The computer system of claim 11, wherein the learning result comprises a similarity parameter, a transformation parameter, a period parameter or an object configuration parameter corresponding to the plurality of identification tags of the plurality of learning objects.

18. The computer system of claim 11, wherein the step of obtaining the analytical result of the learner according to the learning result and the learning principle of the learning estimation method further comprises:
obtaining a learner input result corresponding to the plurality of learning objects operated by the learner according to the leaning result; and
comparing differences between the learner input result and the learning principle, to obtain the analytical result of the learner.

19. The computer system of claim 18, wherein the analytical result comprises determining a learning goal achievement percentage, a responsive rate, a thinking process or a cognitive psychology of the learner.

20. The computer system of claim 11, further comprises an object recognition module and an object sensing module for recording changes of the plurality of identification tags while the learning operation is been processed to obtain the learning result, and an analysis module predetermining the learning principle for obtaining the analytical result of the learner according to the learning result.
